(19) United States
(12) Patent Application Publication
(10) Pub. No.: US 2014/0261204 A1
(43) Pub. Date: Sep. 18, 2014

(54) Pet Feeder

(71) Applicant: Evanjelina Cruz, McAllen, TX (US)

(72) Inventor: Evanjelina Cruz, McAllen, TX (US)

(21) Appl. No.: 13/948,227

(22) Filed: Jul. 23, 2013

Related U.S. Application Data
(60) Provisional application No. 61/790,053, filed on Mar. 15, 2013.

(51) Int. Cl. A01K 9/00; A23K 1/18

(52) U.S. Cl. CPC A01K 9/005; A23K 1/1893
USPC 119/71; 426/587

(57) ABSTRACT

An animal feeder comprising a body having one or more fabric pieces defining a closed space, and a bed. The body has a base and an opposing end. A flap is attached to the body and has a free end, with the flap defining openings proximal to the free end. Pockets are adjacent to the body and have open ends alignable with the flap openings. Fluid vessels occupy the pockets.

### CROSS-REFERENCES TO RELATED APPLICATIONS

This original, nonprovisional application claims the benefit of the filing date of U.S. provisional application Ser. No. 61/790,053, filed Mar. 15, 2013, which is incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention relates to an animal feeder. More specifically, the invention is a device for nursing one or more animals while simulating the feel and warmth that would otherwise be provided by the animals' mother.

2. Description of the Related Art

Taking care of a baby animal or newborn litter can be exasperating. Often, an animal mother will reject its offspring and not allow it to nurse. In other circumstances, the mother is disabled, or simply unable to nurse for physical reasons.

In these cases, the human caretaker must ensure that the offspring receive adequate nutrition. Often, the caretaker may provide the offspring with milk or formulate with a nursing bottle. Sometimes, however, the offspring will refuse to drink from the bottle. Other times, there are simply too many offspring to handle.

### BRIEF SUMMARY OF THE INVENTION

The present invention allows a user to provide young animals with the warmth, comforting, and nursing action of the animals' mother, making it easier to care for the animals while also providing a comfortable area in an otherwise strange environment. The present invention may be used with puppies, kittens, or any other type of animal.

The present invention comprises a body having one or more fabric pieces defining a closed space, and a bed. The body has a base and an opposing end. A flap is attached to the body and has a free end, with the defining flap openings proximal to the free end. Pockets are adjacent to the body and have open ends alignable with the flap openings. Fluid vessels occupy the pockets.

### BRIEF DESCRIPTION OF THE SEVERAL VIEWS OF THE DRAWINGS

FIG. 1 shows a front view of a preferred embodiment of the present invention.

FIG. 2 shows an alternative front view of the preferred embodiment.

FIG. 3 shows a reverse view of the embodiment shown in FIGS. 1-2.

### DETAILED DESCRIPTION OF VARIOUS EMBODIMENTS OF THE INVENTION

Referring to FIG. 1, the embodiment 20 comprises a body 22 made from a number of attached (e.g., sewn together) fabric pieces, including fabric pieces 24a-c, to define a closed spaced containing a soft filler material 25 (e.g., cotton). The body 22 has a base 26 and an end 28 opposing the base 26. The base 26 is wider than the opposing end 28 and has a generally ovular footprint. The area of the base 26 relative to the distance to the opposing end 28 allows the embodiment 20 to rest on the base 26 when placed on a surface with the opposing end 28 free and distal from the surface.

A flap 32 extends from the body 22 proximal to the opposing end 28. The flap has a free end 36, an inner surface 40 and an outer surface 41. A number of circular flap openings 34 extend between the inner surface 40 and outer surface 41 near the free end 36. A fastener, such as a strip of hook-and-loop material 38a, is attached to the inner surface 40 of the flap 32 near the free end 36. A corresponding strip of hook-and-loop material 38b is attached to the outer surface 42 of the casing 24 approximately midway between the base 26 and the opposing end 28.

Referring back to the body 22, pockets 46 are attached to the fabric piece 24b between the fastener strip 38b and the opposing end 28. Each pocket 46 has a closed end 44 and defines a generally cylindrical space accessible through a corresponding open end 48. Each open end 48 is alignable with one of the flap openings 34 when the flap 32 is closed and the hook-and-loop strips 38a-b are connected. The flap openings 34 are smaller in diameter than the open ends 48 of the pockets 46.

The embodiment 20 further includes a number of fluid vessels, such as angled baby bottles 50. Each bottle 50 has a closed end 52 and a teated end 54 that terminates with a non-drip nipple. The bottles 50 occupy the pockets 46 with the teated ends 54 positioned outside of the flap 32.

A cloth pouch 58 is positioned in each pocket 46 at its closed end 44 and adjacent to the closed end 52 of a bottle 50. Each pouch 58 contains a heat-retaining material, such as rice grains, that may be used to transfer heat to the contents of the adjacent bottle 50, as will be described infra.

The embodiment 20 further comprises a bed 60 made from a soft fabric piece 62. An elongated cushion 64 is attached along a portion of the perimeter of the piece 62.

FIG. 2 shows the flap 32 closed around the bottles 50, with hook-and-loop strips 38a-b (not shown) attached. The bottles 50 extend through the flap openings 34 and are directed generally toward the attached bed 60. An annular elastic band 56 is sewn into the flap 32 around each flap opening 34 and constricts around the corresponding bottle 50 to inhibit movement of the bottle 50. A handle 30 is attached to the body 22 at the opposing end 28.

FIG. 3 shows the attachment between the body 22 and bed 60 in more detail. A fastener, such as hook-and-loop strip 66a, is attached along a portion of the perimeter P of the fabric piece 62. An elongate cushion 64 is fixed along the remainder of the perimeter P. The fabric piece 62 is attached to the body 22 by connecting the strip 66a to a corresponding hook-and-loop strip 66b.

A pocket 68 is formed proximal to the base 26 between the fabric piece 24f and a fabric piece 24g. The fabric piece 24g is attached to pieces 24c, 24e and partially defines the space containing the filler material and separates the filler material from the pocket 68. A cloth pouch 70 contains a heat-retaining material and may be placed in the pocket 68.

The preferred method of use of the embodiment 20 is described initially with reference to FIG. 1, in which the flap 32 is unfastened from the body 22 to allow access to the pockets 46. The pouches 58 are placed in a microwave and heated for no more than thirty seconds to reach a desired temperature to avoid burning the pouches 58, following which one pouch 58 is placed in each of the pockets 46 against the closed end 44. Thereafter, a bottle 50 containing a nutrient-rich mixture is inserted into each pocket 46, with the closed end 52 positioned adjacent to the corresponding pouch 58. Warming the smaller pouches 58 in this manner, inserting the pouches 58 first into the pockets 46, and positioning them against the bottles 50 will tend to adequately heat any contained mixture for approximately one hour depending on the heating temperature. It should be noted, however, that warming the pouches 58 for longer than this period of time could result in burning or injury to the user or damage to the pouches 58. Care should be taken to adjust the heating time depending on the power settings of the microwave.

The flap 32 is then pulled toward the base 26 and over the pockets 46 and bottles 50, and the flap openings 34 oriented around the bottles 50. Because the flap openings 34 are smaller than the profile of the bottles 50, and because of the constriction of the elastic bands 56 around the bottles 50, bottles 50 are inhibited from moving from the pockets 48 by the flap 32. The teated ends 54 of the bottles protrude toward the bed 60.

Although FIG. 1 shows the flap 32 unattached from the fabric piece 24b, a portion of the flap 32 may be attached to the fabric piece 24b at or proximal to points 33 to inhibit removal of the flap 32 to the position to the position shown in FIG. 1. Restricting removal of the flap 32 helps to exert a continual force toward the pockets 46 to hold the bottles 50 in the pockets 46. Such attachment may be through additional hook-and-loop strips, sewing attachment, or other suitable means.

The connection between the bed 60 and the body 22 simulates the area under and proximal to a nursing animal's belly into which the offspring can nestle while nursing from the teated ends 54. The second cushion 64 acts as a barrier to inhibit the offspring from moving off the fabric piece 62, while also providing support of the offspring to use as leverage while nursing. Because the fabric piece 62 is bounded around its entire perimeter P with either the cushion 64 or attachment to the base 26, the offspring are urged to stay in the bed 60.

Referring to FIG. 3, the larger pouch 70 and heat-retaining material are heated in a similar manner described with reference to FIG. 1, following which the pouch 70 will have to be filled with heat-retaining material heated one-and-a-half minutes on each side until a desired temperature is reached. Warming the pouch 70 for an excessive period of time could result in injury to the user or damage to the pouch 70.

Thereafter, the pouch 70 is placed in the pocket 68, which simulates the body heat of a nursing mother. In addition, the weight of the larger pouch 70 and its contents adds stability to the embodiment 20 by making it more difficult (compared to when the pocket 68 is unoccupied) to tip the embodiment 20 off the base 26 when it otherwise rests on a surface in an upright position (i.e., the position shown in FIG. 1).

The preferred nursing fluid is the mixture of two twelve-ounce cans of condensed milk, one cup of plain yogurt, four egg yolks, one tablespoon of corn syrup, one cup of hot water. These ingredients are to be whipped for one minute and the left to stand for fifteen minutes, which will cause the mixture to thicken.

For clarity, the space holding the filler material 25 is defined by fabric pieces 24a-e and 24g. Fabric piece 24f is stitched to pieces 24c, 24e and defines the base 26. Attachment between the various fabric pieces is shown in the figures as stitching S.

The present disclosure includes preferred or illustrative embodiments in which a specific animal feeder is described. Alternative embodiments can be used in carrying out the invention as claimed and such alternative embodiments are limited only by the claims themselves. For example, alternative embodiments may be formed so that the body is shaped like the nursing mother, such as in the general shape of a dog or a cat. Other aspects and advantages of the present invention may be obtained from a study of this disclosure and the drawings, along with the appended claims.

I claim:

1. An animal feeder comprising:
a body having one or more fabric pieces defining a closed space, the body having a base and an opposing end;
a volume of filler material occupying the closed space;
a flap attached to the body and having a free end, said flap defining at least one flap opening proximal to the free end;
at least one pocket adjacent to the body having an open end;
a bed attachable to the body; and
at least one fluid vessel having a teated end, said at least one fluid vessel occupying said at least one pocket.

2. The animal feeder of claim 1 wherein said flap is extends from the body proximal to the opposing end.

3. The animal feeder of claim 1 further comprising:
a first fastener attached to the body between the base and the opposing end; and
a second fastener engagable with said first fastener and attached to an inner surface of said flap.

4. The animal feeder of claim 1 further comprising a pouch containing a heat-retaining material, said pouch being enclosed within said body.

5. The animal feeder of claim 4 wherein one one or more fabric pieces define a pocket having an opening proximal to the base, said pouch occupying said pocket.

6. The animal feeder of claim 1 wherein said bed comprises:
a fabric piece having a perimeter;
a second cushion extending from said fabric piece along a portion of a perimeter; and
wherein said perimeter terminates at the second cushion and the body

7. The animal feeder of claim 6 wherein said base is in contact with the fabric piece.

8. The animal feeder of claim 1 further comprising at least one pouch containing a heat-retaining material, said at least one pouch occupying said at least one pocket adjacent to said at least one fluid vessel.

9. The animal feeder of claim 1 wherein said at least one fluid vessel occupies said at least one flap opening.

10. The animal feeder of claim 1 further comprising at least one an annular elastic member circumscribing said at least one flap opening.

11. The animal feeder of claim 1 wherein said at least one pocket has a closed end positioned between said open end and said opposing end of said body.

12. The animal feeder of claim 1 wherein the teated end of said at least one fluid vessel extends toward said bed.

13. A fluid mixture resulting from combining the following ingredients:
twenty-four ounces of condensed milk;
one cup of yogurt;
four egg yolks;
one tablespoon of corn syrup; and
one cup of hot water.
